(19) United States
(12) Patent Application Publication
(10) Pub. No.: US 2013/0144742 A1
(43) Pub. Date: Jun. 6, 2013

(54) USER LICENSE USAGE VERIFICATION

(71) Applicants: Damandeep Thakur, Bangalore (IN); Santosh N, Bangalore (IN); Horst Schaude, Kraichtal (DE)

(72) Inventors: Damandeep Thakur, Bangalore (IN); Santosh N, Bangalore (IN); Horst Schaude, Kraichtal (DE)

(73) Assignee: SAP AG, Walldorf (DE)

(21) Appl. No.: 13/311,156

(22) Filed: Dec. 5, 2011

(51) Int. Cl. G06Q 30/06

(52) U.S. Cl. 705/26.1

(57) ABSTRACT

Embodiments of the present invention may provide a method to verify license usage. The method may comprise replicating existing license order(s) to a license management server, sending software usage information to the license management server, extracting the usage information and order information independently, consolidating the usage information and order information independently, and calculating license usage and determining a license strategy for the software usage.

### FIELD OF THE INVENTION

The disclosure relates to a system and method for providing user license usage verification, and in particular, user license calculation and validation in a subscription based licensing scheme.

### BACKGROUND

Business entities and government agencies depend more and more on software applications in daily operations. Traditionally, software applications have to be installed at the sites of the business entities and government agencies. With the development of the internet based cloud computing, computing becomes a service rather than a product such that shared resources, software, and information are provided to user work stations and other devices as a utility over a network (e.g., Internet). In this trend, software as a service, or software on-demand, provides a new business model for software customers to procure computing service, in which the software customers purchase licenses to subscribe to software services hosted by service providers (e.g., software vendors or application service providers).

In an on-demand solution, customers typically buy licenses from the service vendors. A software application normally has different levels of functionalities and provide different license types for customers to choose. These licenses are priced according to the capabilities offered. A customer usually has to pay more for access to more functionalities and buy more number of licenses for more number of users.

In the conventional licensing scheme, a particular license type covers only certain functions provided by a software application and blocks the user's access to other functions. However, the conventional licensing scheme is problematic for both the customers and service providers. For the customers, in a lot of times, they do not know what level of functionality fit their respective business needs. Thus, the customers want access to other functionalities beyond what they have paid and stop paying for functionalities they do not use. For the service providers, they want to let customers try out other functionalities to entice customers to purchase more licenses for more functionalities and also make customers happy. Accordingly, there is a need in the art for service providers to allow customers to use software services not yet covered by the purchased licenses but let customers adjust the subscriptions accordingly either by purchasing additional licenses, or by switching off functions from currently assigned users to come down to the licensed mark.

### BRIEF DESCRIPTION OF THE DRAWINGS

FIG. 1 illustrates a block diagram according to an exemplary embodiment of the present invention.

FIG. 2 illustrates a process of calculating user license usage according to an exemplary embodiment of the present invention.

FIG. 3 illustrates an exemplary system implementation according to an exemplary embodiment of the present invention.

FIG. 4 illustrates a structure of a computer providing a user license usage verification according to an exemplary embodiment of the present invention.

### DETAILED DESCRIPTION

Embodiments of the present invention may provide a method to verify license usage. The method may comprise replicating existing license order(s) to a license management server, sending software usage information to the license management server, extracting the usage information and order information, consolidating the usage information and order information, and calculating license usage and finding out a best license strategy for the software usage.

In an embodiment, customers may buy licenses for using an on-demand software application from a service provider. These licenses may be priced according to the capabilities offered. While a particular license type may allow only certain functions, usage of the on-demand software application is not restricted to those certain functions covered by the particular license type. Rather, the service provider may allow its customers to use more functions than those covered by the purchased licenses. Any overuse may be used an indicator for the customer to adjust the subscriptions accordingly (e.g., example, by purchasing additional licenses, or by switching off functions from currently assigned users to come down to the licensed mark).

One embodiment of the present invention may calculates which licensed have been purchased and are used (currently valid) by a customer for currently used functions. A comparison may be made between the number of licensed and assigned users based on the assigned work screens. To clarify any overuse, the number of licensed users and assigned users may be marked respectively. In one embodiment, this comparison may be created repeatedly for a period of time (e.g., weekly, monthly, quarterly). For example, the comparison may be grouped by different user types and the user data may be anonymous. Any changes of the numbers, for example, either in the subscription of users or in the assignment of users, may be visible in a report of the comparison within a certain time (e.g., less than 5 minutes, less than 15 minutes, etc.). The report may be available to staff of the customer, the service provider, or both.

In one embodiment, a customer may trigger an initial order with a service provider. The initial order may be created in the service provider's CRM system. This initial order may contain item products bought by customer. In this case, the products may be one or more usage license types for a software application provided by the service provider. Every license type may be for performing a certain set of business functions. Each business function may be covered by more than one license type. The customer can also request additional orders and renewal orders. These orders may have validity for a certain period of time (e.g., one or more months, one or more quarters, or one or more years).

The order data may be replicated to a license management server (e.g., a service provider cockpit system) of the service provider. In an embodiment, the servicer provider may host a software application for a plurality of customers with each customer being a tenant of the hosted software application. The license management server may be a central place for the service provider to manage the entire customer tenant related information. In a productive environment, the customer may have administrative staff that has authority to change a level of access of any software application users. On any such change, the usage of the software application may be calculated based on UI components assigned to users (more detail below). This usage information may be replicated from the software application to the license management server. The usage data may also have validity for a duration. If the usage assignment for a user is changed, the change may result in a change in license (e.g., stop using a license) and the validity is adjusted accordingly.

In one embodiment, a user for a particular customer may query, using the software application, for subscription relation information for a given validity. The query of the user may have a validity assigned to it (e.g., today, last month, last quarter). In response, a license calculation engine installed on the license management server may consider the license types, validity, usage and order data, and create a record for every month, valid as of a specific date. The license calculation engine may calculate the license usage based on existing licenses and their quantity bought by the particular customer, based on a best fit mechanism to find the cheapest possible license for that usage. This data also includes over usage count, whenever possible. Then, the calculation result may be made accessible from the software application to the license management server.

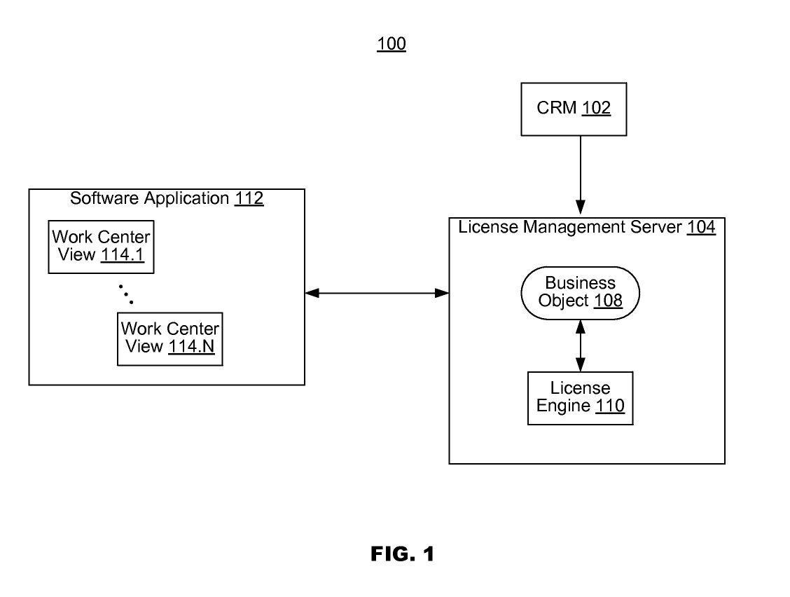

FIG. 1 illustrates a block diagram of an exemplary software system 100 according to an embodiment of the present invention. The software system 100 may comprise a customer relation management (CRM) system 102, a business software application 112, and a license management server 104. The CRM system 102 may be a license storage server that keeps all orders for licenses. The license management server 104 may be a service provider management server that also functions as a license management server. The license management server 104 may include a license engine 110 and instantiate a business object 108 that uses the license engine 110 to perform license calculations. The business software application 112 may present business functionalities in a plurality of user interface (UI) components (e.g., work center views 114.1˜114.N, in which N may be an integer larger than one). These UI components may comprise the functionality the customer is using/accessing. In an embodiment, every work center view may be a user interface screen that is assigned to one or more tag type values and each UI component may be assigned at least one tag type value. Each tag type may be a piece of information indicating to which user type the work center view may belong. That is, in an embodiment, each tag type may correspond one-by-one to a user type.

In an embodiment, a customer may have an initial order of user licenses for the software application 112. After the initial order, the customer may also have additional order(s), renewal order(s), or both. Each order has a validity for a duration. Thus, the customer may need to prolong the validity of the initial order if the customer wants to us the software application 112 after the end of the validity of the initial order. This prolongation may be the renewal orders (with their own validities respectively). Furthermore, if the customer needs to adapt the license (e.g., buy additional licenses for users), the customer may do this with additional orders. Each order may contain information about what type of users and how many users per type are subscribed by the customer. Once confirmed, each order may be become a contract that is originated in the CRM system 102. Confirmed orders may be replicated from the CRM system 102 to the license management server 104 (e.g., into the business object 108). In one embodiment, each additional and renewal order may have a reference to the initial order for the same customer. Validity of each order may be updated and update of validity of the orders may also be sent to the license management server 104. In one or more embodiments, the complete information for each order may be sent to the license management server 104 instead of the changes (e.g., delta) of the respective order.

The license management server 104 may find possible best fit user license types by collected order information and usage information (e.g., all work center views assigned to each user), and calculate an intersection of tag type values. In an embodiment, the subscription calculation may be derived in four stages. In a first stage, the date of validity of each license may be found for a given period. For example, the order information replicated from the CRM system 102 to the license management server 104 may be searched. The period of time searched may be last three months, last six months, current month or current year. The search may identify all licenses to be valid for the given period and valid dates of each license during the given period. In a second stage, the usage and order information data may be extracted into a table. In one embodiment, the extraction may be performed independently for the usage and order information. The usage information may include how many users are assigned to each user group (e.g., user type) to be given access to certain work center views. The usage information may also include how many users are actually accessing each work center views in a certain time period (e.g., last 24 hours, last 7 days, last month, etc.). The usage information may be tracked and collected by the software application 112, and replicated from the software application 112 to the business object 108 of the license management server 104.

In a third stage, the usage information and the order information data may be consolidated based on the required date parameter (e.g., period of time). The consolidation may be performed independently for the usage and order information as well. In a fourth stage, the license engine 110 may be provided with the usage information and the order information data for a given set of dates and may match the usage information to the order information for each license type available. The license engine 110 may create record for every time period (e.g., month, quarter, year, etc) and the record may be valid as on a specific date. The license engine 110 may also calculate the license usage based on existing licenses and their quantity bought by customer. In one embodiment, the license usage calculation may be based on a best fit mechanism. The calculation result may be replicated from the license management server 104 to the software application 112 data so that so that the customer may review the cheapest possible license for that usage. Further, if the customer assigned more users to a work center view than number of licenses purchased, over usage count may also be available to be presented to the customer.

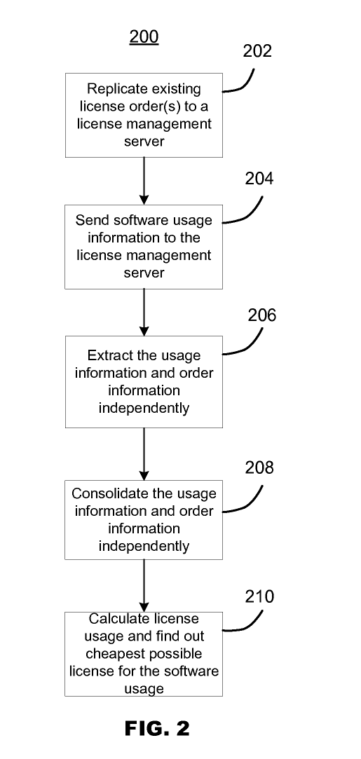

FIG. 2 illustrates a process 200 of calculating user license usage according to an exemplary embodiment of the present invention. At step 202, any existing license order(s) may be replicated to a license management server. For example, a service provider may use a CRM system (e.g., the CRM system 102) to maintain subscription orders for services. Each service provided by the service provider may be a software application (e.g., the software application 112). The service orders for one customer may include an initial order, additional orders and renewal orders. Each additional and renewal order may have a reference to the initial order. In one embodiment, only the confirmed orders may be replicated to the license management server (e.g., the license management server 104). The license management server may include control central server and license engine as described above.

At step 204, the software usage information may be sent to the license management server. A customer may assign one or more users to use the software application. In one embodiment, as described above, the functionalities provided by the software application may be limited by the variety of screen or UI components (e.g., work center views) a user assigned access to. Each work center view may have a tag type value corresponding a certain user type. Each user may be assigned to a particular user type. Thus, the software usage information may include the number of user types and number of users for each user type.

At step 206, the usage information and order information may be extract. For example, a database table may be established at the license management server. The usage information and order information may be extracted and saved into the database table respectively. In one embodiment, the steps 202, 204 and 206 may be run in parallel (e.g., concurrently) or in any order.

At step 208, the usage information and order information may be consolidate independently. For example, a date parameter may be specified. The date parameter may be a specific date, a period of time (e.g., one or more weeks, one or more months, one or more quarters, one or more years, etc.). The license management server may be configured to find out on a specific date or during a period of time, how many users are assigned to each user type, how many licenses the customer has purchased for each tag type. In one embodiment, when the licensing engine is requested to give information for a particular date period, only the usage and order information for that period may be considered. At step 210, the license usage may be calculated and cheapest possible license(s) for the software usage may be found out. In one embodiment, the calculation results may also be replicated to software application to let the customer review the license usage and over usage, if applicable.

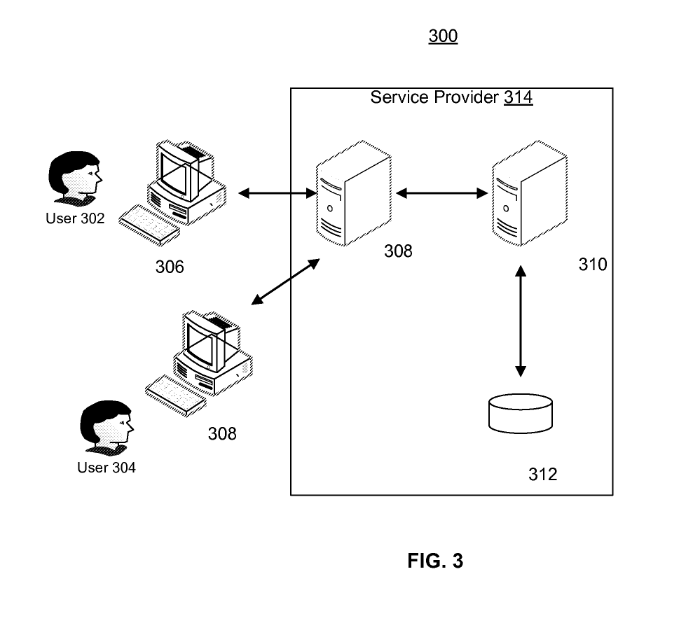

FIG. 3 illustrates an exemplary system 300 implementation according to an exemplary embodiment of the present invention. In the exemplary system 300, a business application may be hosted by a service provider 314 and installed on a server 308 maintained by the service provider 314. The service provider 314 may also maintain a license management server 310 and a database system 312. Users 302 and 304 may belong to a subscribed business customer of the service provider 314 and they may access the business application through their workstations 306 and 308 respectively. Each user 302 or 304 may be assigned to a respective user type according to customer's business needs. Thus, each user 302 and 304 may be given different access levels to functionalities provided by the business application. In one embodiment, access to the business application may provide via a network not controlled by either the customer or the service provider (e.g., the Internet).

The license management server 310 may host a licensing engine 110 and business object 108. The database system 312 may be a storage for a CRM system 102. Thus, usage information for the business application may be collected at the server 308 and replicated to the license management server 310. Also, the order information for the licenses may also be replicated from the database system 312 to the license management server 310. In one embodiment, each of the server 308, license management server 310, and database system 312 may be hosted separately by a respective physical server machine. In another embodiment, any two of them or all of them may be hosted by virtual machines running on one physical server machine.

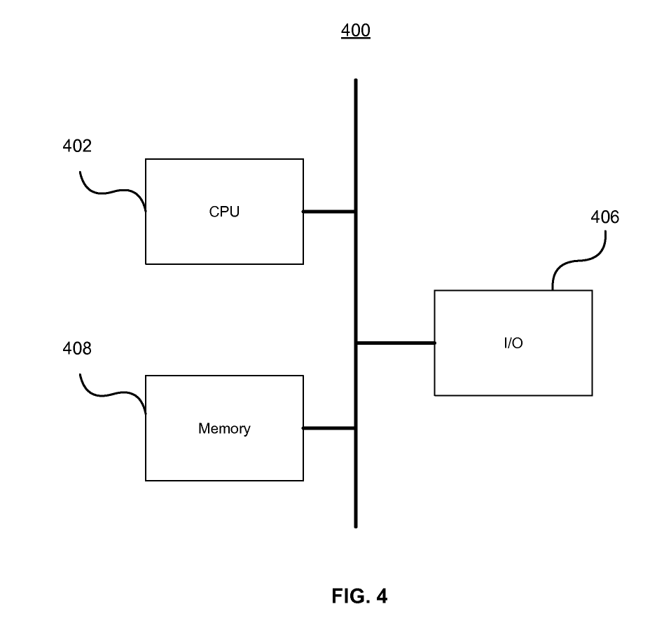

FIG. 4 illustrates a structure of a computer server 400 for license verification according to an exemplary embodiment of the present invention. The computer server 400 includes a processor 402, memory 404, and an I/O device(s) 406. The processor 402 is connected to the memory 404 and I/O device(s) 406. These connections are direct or via other internal electronic circuitry or components.

The processor 402 is a programmable processor that executes instructions residing in the memory 404 to receive and send data via the I/O device(s) 406. The instructions may perform the operations of the license verification described herein. The term programmable processor as used herein is any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 402 is an Intel microprocessor.

Memory 404 is a machine-readable medium that stores data that is processed by processor 402. The term machine-readable medium as used herein is any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 402 via one or more I/O device(s) 406.

The I/O device(s) 406 may be one or more input/output interfaces that receive and/or send digital data to and from an external device. Interfaces as used herein are any point of access to an external device where digital data is received or sent, including ports, buffers, queues, subsets thereof, or any other interface to an external device.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

What is claimed is:

1. A method for providing a user license verification, comprising:
replicating, by a computer server, existing license order(s) for a software application to a license management server;
sending, by the computer server, software usage information to the license management server;
extracting, by the computer server, the software usage information and order information;
consolidating, by the computer server, the software usage information and order information; and
calculating, by the computer server, license usage and determining a license strategy for the software usage.

2. The method of claim 1, wherein each of the replicated existing license order(s) is confirmed.

3. The method of claim 2, wherein the replicated existing license order(s) include at least an initial order.

4. The method of claim 3, wherein replicated existing license order(s) include one or more additional orders, or one or more renewal orders, or both additional orders and renewal orders that each has a reference to the initial order.

5. The method of claim 1, wherein the software application provides a plurality of work center views, each work center view is assigned to one or more tag types, and each tag type corresponds to a user type.

6. The method of claim 5, further comprising calculating an intersection of tag types for one user based on all work center views assigned to the user.

7. The method of claim 6, wherein calculating the license usage includes summarizing the existing licenses and quantities of each license, and the license strategy is a best fit mechanism for cheapest possible license(s) for a respective software usage.

8. A non-transitory machine-readable medium storing instructions adapted to be executed by a computer to perform a method comprising:
replicating existing license order(s) to a license management server;
sending software usage information to the license management server;
extracting the usage information and order information;
consolidating the usage information and order information; and
calculating license usage and determining a license strategy for the software usage.

9. The non-transitory machine-readable medium of claim 8, wherein each of the replicated existing license order(s) is confirmed.

10. The non-transitory machine-readable medium of claim 9, wherein the replicated existing license order(s) include at least an initial order.

11. The non-transitory machine-readable medium of claim 10, wherein replicated existing license order(s) include one or more additional orders, or one or more renewal orders, or both additional orders and renewal orders that each has a reference to the initial order.

12. The non-transitory machine-readable medium of claim 8, wherein the software application provides a plurality of work center views, each work center view is assigned to one or more tag types, and each tag type corresponds to a user type.

13. The non-transitory machine-readable medium of claim 12, further comprising calculating an intersection of tag types for one user based on all work center views assigned to the user.

14. The non-transitory machine-readable medium of claim 13, wherein calculating the license usage includes summarizing the existing licenses and quantities of each license, and the license strategy is a best fit mechanism for cheapest possible license(s) for a respective software usage.

15. A computer system for providing a user license verification, comprising:
a memory to store computer program instructions; and
a processor configured to execute the computer program instructions to:
replicate existing license order(s) to a license management server;
send software usage information to the license management server;
extract the usage information and order information;
consolidate the usage information and order information; and
calculate license usage and determining a license strategy for the software usage.

16. The computer system of claim 15, wherein each of the replicated existing license order(s) is confirmed.

17. The computer system of claim 16, wherein the replicated existing license order(s) include at least an initial order.

18. The computer system of claim 17, wherein replicated existing license order(s) include one or more additional orders, or one or more renewal orders, or both additional orders and renewal orders that each has a reference to the initial order.

19. The computer system of claim 15, wherein the software application provides a plurality of work center views, each work center view is assigned to one or more tag types, and each tag type corresponds to a user type.

20. The computer system of claim 19, further comprising calculating an intersection of tag types for one user based on all work center views assigned to the user.

21. The computer system of claim 20, wherein calculating the license usage includes summarizing the existing licenses and quantities of each license, and the license strategy is a best fit mechanism for cheapest possible license(s) for a respective software usage.
